(19) United States
(12) Patent Application Publication
(10) Pub. No.: US 2009/0294240 A1
(43) Pub. Date: Dec. 3, 2009

(54) DRIVE SHAFT ADAPTED FOR USE BETWEEN A PLURALITY OF DIFFERENT MECHANISMS

(75) Inventors: Donald J. Christensen, Phoenix, AZ (US); Med Osman, Gilbert, AZ (US); Louie T. Gaines, Phoenix, AZ (US); Peter J. Auer, Chandler, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/847,862

(22) Filed: Aug. 30, 2007

(51) Int. Cl. F16D 11/14

(52) U.S. Cl. 192/69

(57) ABSTRACT

A drive shaft is configured to be disposed between a drive mechanism and a plurality of driven mechanisms and to transfer a drive torque generated by the drive mechanism to one of the plurality of driven mechanisms. The drive shaft includes a first shaft section and a second shaft section. The first shaft section has a first outer diameter, and is dimensioned to be disposed within the drive mechanism, within one of the plurality of driven mechanisms, or simultaneously within the drive mechanism and one of the plurality of driven mechanisms. The first shaft section is also configured to at least selectively engage, and thereby at least selectively receive the drive torque generated in, the drive mechanism. The second shaft section is coupled to the first shaft section and has a second outer diameter that is less than the first outer diameter. The second shaft section is dimensioned to be disposed within either the drive mechanism or one of the plurality of driven mechanisms.

### TECHNICAL FIELD

The present invention generally relates to drive shafts for transferring torque from one mechanism to another and, more particularly, to drive shafts adapted for use between with a plurality of different mechanisms.

### BACKGROUND

Aircraft typically include several drive mechanisms that are coupled to driven mechanisms via drive shafts. The drive mechanisms are used to supply a drive torque to drive one or more driven mechanisms. These mechanisms, which may include, for example, a motor (e.g., a drive mechanism) and a gearbox (e.g., a driven mechanism), are preferably coupled in such a way as to facilitate mechanism maintenance and/or replacement. As such, these mechanisms are many times referred to as line replaceable units (LRUs).

During the lifetime of an aircraft, the designs of LRUs often evolve into improved or higher capacity models. As a result, it is oftentimes desirable to replace one or more LRUs in an aircraft. Unfortunately, it can be difficult to couple an older model LRU to a newer model LRU, or to couple to newer model LRUs together. In many instances this difficulty resides in the fact that different sized or configured drive shafts may be needed to transfer the drive torque from the drive mechanism LRU to the driven mechanism LRU. This difficulty can lead to increased overall LRU replacement costs.

Hence, there is a need for a device that allows for the ready replacement and coupling of older and newer model drive mechanism LRUs and older and newer model driven mechanism LRUs. The present invention addresses at least this need.

### BRIEF SUMMARY

In one embodiment, and by way of example only, a drive shaft configured to be disposed between a drive mechanism and a plurality of driven mechanisms and to transfer a drive torque generated by the drive mechanism to one of the plurality of driven mechanisms includes a first shaft section and a second shaft section. The first shaft section has a first outer diameter, and is dimensioned to be disposed within the drive mechanism, within one of the plurality of driven mechanisms, or simultaneously within the drive mechanism and one of the plurality of driven mechanisms. The first shaft section is also configured to at least selectively engage, and thereby at least selectively receive the drive torque generated in, the drive mechanism. The second shaft section is coupled to the first shaft section and has a second outer diameter that is less than the first outer diameter. The second shaft section is dimensioned to be disposed within either the drive mechanism or one of the plurality of driven mechanisms. When the first shaft section is simultaneously disposed in both the drive mechanism and the driven mechanism, the first shaft section simultaneously engages the drive mechanism and the driven mechanism, and transfers the drive torque to the driven mechanism. When the first shaft section is not disposed in the driven mechanism, the second shaft section engages, and transfers the drive torque to, the driven mechanism.

In another embodiment, a drive shaft configured to be disposed between a drive mechanism and a plurality of driven mechanisms and to transfer a drive torque generated by the drive mechanism to one of the plurality of driven mechanisms includes a first shaft section, a second shaft section, a quill shaft passageway, and a quill shaft. The first shaft section has a first outer diameter and an end surface that defines a drive shaft first end. The first shaft section is dimensioned to be disposed within the drive mechanism or simultaneously within the drive mechanism and one of the plurality of driven mechanisms. The first shaft section is also configured to at least selectively engage, and thereby at least selectively receive the drive torque generated in, the drive mechanism. The second shaft section is coupled to the first shaft section and has a second outer diameter and an end surface that defines a drive shaft second end. The second outer diameter is less than the first outer diameter, and the second shaft section is dimensioned to be disposed within either the drive mechanism or one of the plurality of driven mechanisms. The quill shaft passageway extends longitudinally through the drive shaft between the first and second shaft ends. The quill shaft is disposed within the quill shaft passageway and extends from the drive shaft first and second ends. When the first shaft section is simultaneously disposed in both the drive mechanism and the driven mechanism, the first shaft section simultaneously engages the drive mechanism and the driven mechanism, and transfers the drive torque to the driven mechanism. When the first shaft section is not disposed in the driven mechanism, the second shaft section engages, and transfers the drive torque to, the driven mechanism.

In yet another embodiment, a drive shaft configured to be disposed between a drive mechanism and a plurality of driven mechanisms and to transfer a drive torque generated by the drive mechanism to one of the plurality of driven mechanisms includes a first shaft section, a shaft engagement groove, and a second shaft section. The first shaft section has a first outer diameter and an outer peripheral surface. The first shaft section is dimensioned to be disposed within the drive mechanism or simultaneously within the drive mechanism and one of the plurality of driven mechanisms. The first shaft section is also configured to at least selectively engage, and thereby at least selectively receive the drive torque generated in, the drive mechanism. The shaft engagement groove is formed in at least a portion of the first shaft section outer peripheral surface. The second shaft section is coupled to the first shaft section and has a second outer diameter that is less than the first outer diameter. The second shaft section is dimensioned to be disposed within either the drive mechanism or one of the plurality of driven mechanisms. When the first shaft section is simultaneously disposed in both the drive mechanism and the driven mechanism, the first shaft section simultaneously engages the drive mechanism and the driven mechanism, and transfers the drive torque to the driven mechanism. When the first shaft section is not disposed in the driven mechanism, the second shaft section engages, and transfers the drive torque to, the driven mechanism.

In still another embodiment, a drive shaft configured to be disposed between a drive mechanism and a plurality of driven mechanisms and to transfer a drive torque generated by the drive mechanism to one of the plurality of driven mechanisms includes a first shaft section, a second shaft section, and an intermediate shaft section. The first shaft section has a first outer diameter, and is dimensioned to be disposed within the drive mechanism or one of the plurality of driven mechanisms. The second shaft section is coupled to the first shaft section and has a second outer diameter that is less than the first outer diameter. The second shaft section is dimensioned to be disposed within either the drive mechanism or one of the plurality of driven mechanisms. The intermediate shaft section is disposed between, and is coupled to, the first and second shaft sections. The intermediate section has a third outer diameter that is greater than the first and second outer diameters, and is configured to engage, and thereby receive the drive torque generated in, the drive mechanism. The intermediate shaft section, when engaging the drive mechanism, transfers the drive torque to the driven mechanism via either the first shaft section or the second shaft section.

### BRIEF DESCRIPTION OF THE DRAWINGS

The present invention will hereinafter be described in conjunction with the following drawing figures, wherein like numerals denote like elements, and

FIG. 1 is a functional block diagram depicting an exemplary arrangement of a drive mechanism coupled to, and operable to supply a drive torque to, an exemplary driven mechanism;

FIG. 2 is a cross section view of an exemplary drive shaft embodiment coupled between an exemplary drive mechanism and one of a plurality of driven mechanisms;

FIG. 3 is a cross section view of the exemplary drive shaft embodiment of FIG. 2, but coupled between the exemplary drive mechanism and another one of a plurality of driven mechanisms;

FIG. 4 is a cross section view of a second exemplary drive shaft embodiment coupled between an exemplary drive mechanism and one of a plurality of driven mechanisms;

FIG. 5 is a cross section view of the exemplary drive shaft embodiment of FIG. 4, but coupled between the exemplary drive mechanism and another one of a plurality of driven mechanisms;

FIG. 6 is an isometric view of a third exemplary drive shaft embodiment that may be coupled between an exemplary drive mechanism and one of a plurality of driven mechanisms.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

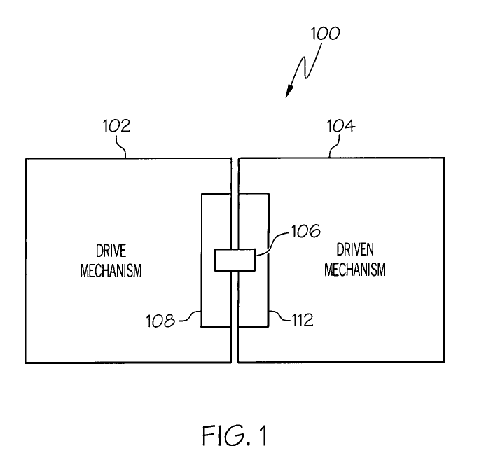

Turning to FIG. 1, a functional block diagram of a drive mechanism/driven mechanism system configuration is depicted. The depicted system 100 includes a drive mechanism 102, a driven mechanism 104, and a drive shaft 106. The drive mechanism 102 is configured to generate a drive torque, which is in turn supplied to the driven mechanism 104. The driven mechanism 104, upon receipt of the drive torque from the drive mechanism 102, rotates one or more components to effect an end result. It will be appreciated that the drive mechanism 102 may be implemented using any one of numerous devices used to generate a drive torque, and the driven mechanism may be implemented using any one of numerous devices responsive to a drive torque. Some non-limiting examples of drive mechanisms 102 include various types of motors and gas turbine engines, just to name a few. Some non-limiting examples of driven mechanisms include various types of actuators and gear boxes, just to name a few.

No matter the specific physical implementation of the drive mechanism 102 and the driven mechanism 104, the drive torque that is generated by the drive mechanism 102 is transferred to the driven mechanism 104 via the drive shaft 106. The drive shaft 106 is preferably configured as a removable and replaceable device. Thus, as FIG. 1 further depicts, the drive mechanism 102 and the driven mechanism 104 each include drive shaft interfaces 108 and 112, respectively. The drive shaft 106 engages the drive shaft interfaces 108, 112 in each mechanism 102, 104, and thereby transfers the torque from the drive mechanism 102 to the driven mechanism 104.

The drive mechanism 102 and the driven mechanism 104 are both preferably configured as line replaceable units (LRUs). Thus, the drive mechanism 102 may be replaced by another drive mechanism 102, and the driven mechanism 104 may be replaced by another driven mechanism 104. However, the replacement drive mechanism 102 or driven mechanism 104 may have, for example, a drive shaft interface 108 or 112 that differs from that of the original mechanism 102, 104. To accommodate this potentiality, the drive shaft 106 is configured such that it may be used with a plurality of different mechanisms 102, 104. Various embodiments for implementing this configuration will now be described.

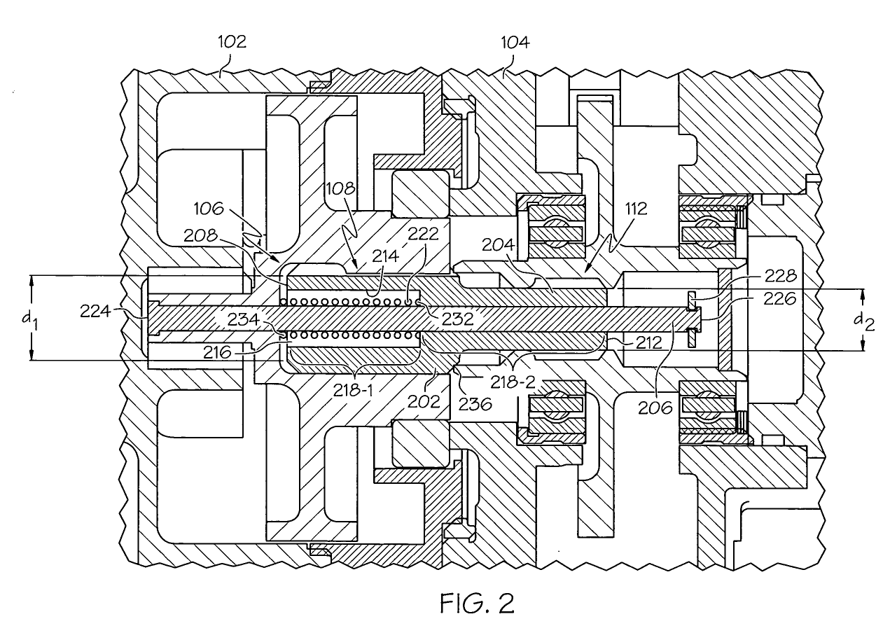

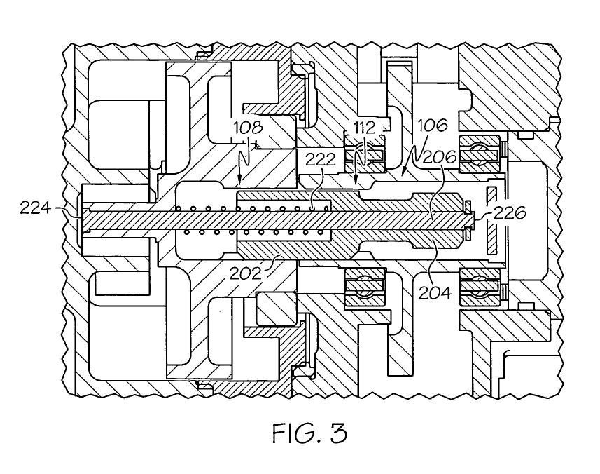

With reference first to FIGS. 2 and 3, it is seen that the depicted drive shaft 106 includes a first shaft section 202, a second shaft section 204, and a quill shaft 206. The first shaft section 202 has a first outer diameter (d₁) and an end surface 208 that defines a drive shaft first end. As FIG. 2 depicts, the first shaft section 202 is dimensioned to be disposed within the drive mechanism 102 and is configured to engage, and thereby receive the drive torque generated by, the drive mechanism 102. As FIG. 3 depicts, the first shaft section 202 is also dimensioned such that it may also be simultaneously disposed within the drive mechanism 102 and the driven mechanism 104, if the driven mechanism drive shaft interface 112 is so configured.

The second shaft section 204 is coupled to the first shaft section 202 and has a second outer diameter (d₂) and an end surface 212 that defines a drive shaft second end. As may be readily apparent from FIGS. 2 and 3, the second outer diameter (d₂) is less than the first outer diameter (d₁). Because the second diameter is less than the first, it will be appreciated that the second shaft section 204 may thus be disposed within either the drive mechanism 102 or the driven mechanism 104. However, in the depicted embodiment, whenever the drive shaft 106 is installed the second shaft section 202 is only disposed within the driven mechanism 104.

The drive shaft 106 additionally includes an inner surface 214 that defines a quill shaft passageway 216. The quill shaft passageway 216 extends longitudinally through the drive shaft 106 between the first and second shaft ends 208, 212. In the embodiment depicted in FIGS. 2 and 3, the quill shaft passageway 216, like the drive shaft 106, has two sections. In particular, the quill shaft passageway includes a first section 218-1 and a second section 218-2. The quill shaft passageway first section 218-1 extends from the first shaft end 208 and at least partially through the shaft first section 202, and the quill shaft passageway second section 218-2 extends from the second shaft end 212 to the quill shaft passageway first section 218-1. Similar to the first and second shaft sections 202, 204, the quill shaft passageway first and second sections 218-1, 218-2 also have differing diameters, with the diameter of the quill shaft passageway first section 218-1 being larger than the diameter of the quill shaft passageway second section 218-2. This is because, as FIGS. 2 and 3 further depict, a spring 222 is disposed in the quill shaft passageway first section 218-1, the purpose of which is described in more detail further below.

The quill shaft 206 is disposed within the quill shaft passageway 216 and extends from the drive shaft first and second ends 208, 212. The quill shaft 206 includes a first end 224 and a second end 226 In the depicted embodiment, the quill shaft diameter is increased at the first end 224, and a stop 228 extends radially from the second end 226. The stop 228 may be formed integrally on the quill shaft second end 226 or may be formed separately and then coupled to the quill shaft second end 226. It will additionally be appreciated that the quill shaft first end 224 may be alternatively configured with an integrally formed, or separately formed and coupled, device. No matter how the quill shaft ends 224, 226 are specifically implemented, each is configured such that once the quill shaft 206 is disposed within the quill shaft passageway 216, it cannot be readily removed. Moreover, the quill shaft first end 224 is configured, when the drive shaft 106 is installed between the drive mechanism 102 and the driven mechanism 104, to engage a portion of the drive mechanism 102.

As was noted above, a spring 222 is disposed within the quill shaft passageway first section 218-1. The spring 222, which is preferably implemented using a suitable coil spring, includes a first end 232 and a second end 234. When the drive shaft 106 is installed between the drive mechanism 102 and the driven mechanism 104, the spring first end 232 engages the quill shaft inner surface 214, and the spring second end 234 engages a portion of the drive mechanism 102.

When the above-described drive shaft 106 is installed in the drive mechanism 102/driven mechanism 104 configuration depicted in FIG. 2, in which the drive mechanism shaft interface 108 is larger than the driven mechanism shaft interface 112, the spring 222 urges the drive shaft 106 toward the driven mechanism 104. However, because the driven mechanism shaft interface 112 is sized to engage the second shaft section 204, first shaft section 202 engages a stop surface 236 in the driven mechanism 104. The second shaft section 204 engages the driven mechanism shaft interface 112, and thereby transfers the drive torque generated in the drive mechanism 102 to the driven mechanism 104. Conversely, when the drive shaft 106 is installed in the drive mechanism 102/driven mechanism 104 configuration depicted in FIG. 3, in which the driven mechanism shaft interface 112 is identical to the drive mechanism shaft interface 108, the spring 222 also urges the drive shaft 106 toward the driven mechanism 104. However, because the driven mechanism shaft interface 112 is sized to also engage the first shaft section 202, a portion of the first shaft section 202 is urged into the driven mechanism 104 and engages the driven mechanism shaft interface 112. Thus, the first shaft section 202 is simultaneously disposed in both the drive mechanism 102 and the driven mechanism 104, the and simultaneously engages the drive mechanism shaft interface 108 and the driven mechanism shaft interface 112, and transfers the drive torque to the driven mechanism 104. In both of these configurations, the quill shaft first end 224 engages a portion of the drive mechanism 102.

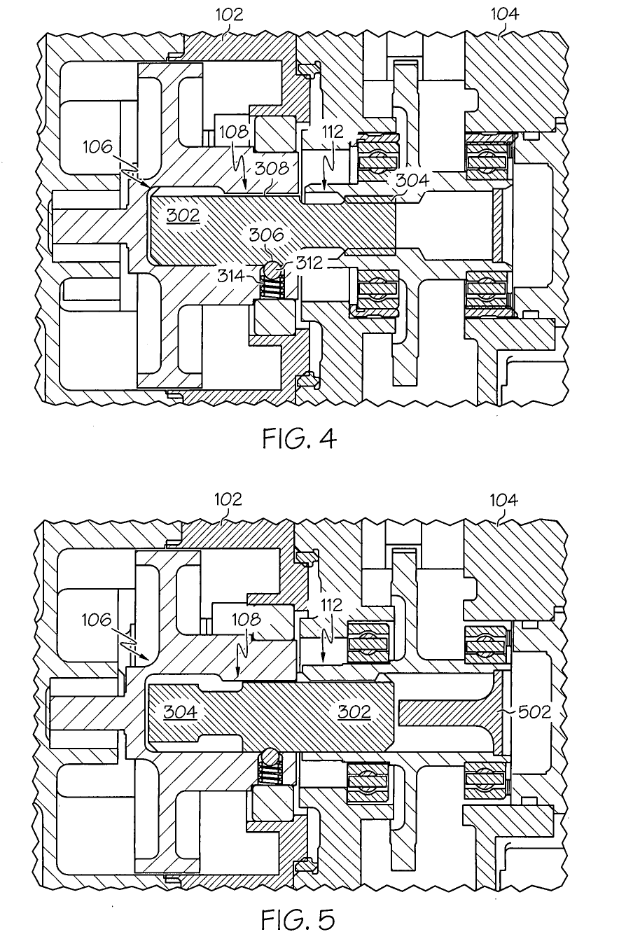

Turning now to FIGS. 4 and 5, an alternatively configured drive shaft is depicted and will be described. Similar to the previously described embodiment, this drive shaft 106 includes a first shaft section 302 and a second shaft section 304, but does not include a quill shaft 206 or a quill shaft passageway 216. It is noted that the first shaft section 302 and the second shaft section 304 of this embodiment are configured substantially identical to the previously described embodiment, and will thus not be described in detail.

The major difference of the drive shaft 106 depicted in FIGS. 4 and 5 is that one or more shaft retaining grooves 306 are formed in an outer peripheral surface 308 of the shaft first section 302. The shaft retaining groove(s) 306 may be configured as ball detents, as depicted in FIGS. 4 and 5, or may alternatively be configured as a retaining ring groove. When the shaft retaining groove 306 is configured as one or more ball detents, one or more detent balls 312 are disposed within the drive mechanism 102 and, via one or more detent springs 314, are spring-loaded to be partially disposed within the one or more shaft retaining grooves 306 to axially retain the drive shaft 106 in place. As FIGS. 4 and 5 also depict, the drive mechanism 102 may be suitably configured or modified to accommodate the one or more springs 314 or non-illustrated retaining rings.

When the above-described drive shaft 106 is installed in the drive mechanism 102/driven mechanism 104 configuration depicted in FIG. 4, in which the drive mechanism shaft interface 108 is larger than the driven mechanism shaft interface 112, the first shaft section 302 is disposed solely in the drive mechanism 102, and engages the drive mechanism shaft interface 108. The second shaft section 304 is disposed within the driven mechanism 104, and engages the driven mechanism shaft interface 112, to thereby transfer the drive torque generated in the drive mechanism 102 to the driven mechanism 104. Conversely, when the drive shaft 106 is installed in the drive mechanism 102/driven mechanism 104 configuration depicted in FIG. 5, in which the driven mechanism shaft interface 112 is identical to the drive mechanism shaft interface 108, the drive shaft 106 is flipped 180-degrees so that the shaft first section 302 is simultaneously disposed in the drive mechanism 102, and the shaft second section 304 is disposed in the drive mechanism 102. As a result, the first shaft section 302 engages both the drive mechanism shaft interface 108 and the driven mechanism shaft interface 112, to thereby transfer the drive torque generated in the drive mechanism 102 to the driven mechanism 104. In both instances, the drive shaft 106 is axially retained, at least partially, via the one or more detent balls 308 in the one or more detent grooves 306. As FIG. 5 further depicts, an additional extended axial retainer 502 may preferably be installed in the driven mechanism.

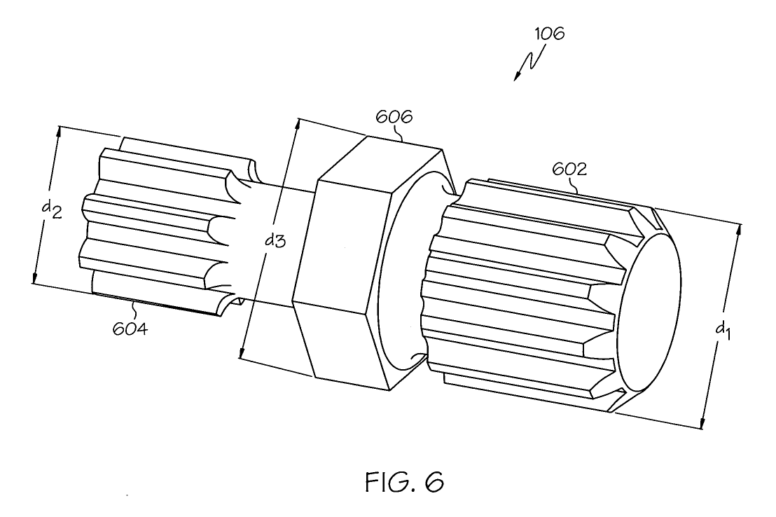

Turning finally to FIG. 6, yet another exemplary drive shaft embodiment is depicted. The depicted drive shaft 106 is configured similar to the embodiment depicted in FIGS. 4 and 5, but does not include the one or more shaft retaining grooves 306. Thus, in addition to including the first shaft section 602 and the second shaft section 604, the drive shaft 106 additionally includes an intermediate shaft section 606. As FIG. 6 depicts, the intermediate shaft section 606 is coupled to, and disposed between, the first and second shaft sections 602, 604. Preferably, the intermediate shaft section 606 has a third outer diameter (d₃) that is larger than the first outer diameter (d₁). With this configuration, the intermediate shaft section 606 is preferably disposed within the drive mechanism 102 and engages the drive mechanism shaft interface 108, and either the first shaft section 602 or the second shaft section 604 is disposed in the driven mechanism 104 and engages the driven mechanism shaft interface 112. As may be appreciated, if the first shaft section 602 is disposed in the driven mechanism 104, then the second shaft section 604 is disposed in the drive mechanism 102, and vice-versa.

In each of the embodiments described above, the first and second shaft sections are depicted with splined configurations, and the intermediate shaft section is depicted with a hex configuration. It will be appreciated that this is merely exemplary, and that each of these shaft sections could be alternately configured, albeit with each having different sizes. No matter the specific configuration of the shaft sections, the drive shaft is configured to be used with a plurality of drive mechanism/driven mechanism combinations.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A drive shaft configured to be disposed between a drive mechanism and a plurality of driven mechanisms and to transfer a drive torque generated by the drive mechanism to one of the plurality of driven mechanisms, the drive shaft comprising:
a first shaft section having a first outer diameter, the first shaft section dimensioned to be disposed within the drive mechanism, within one of the plurality of driven mechanisms, or simultaneously within the drive mechanism and one of the plurality of driven mechanisms, the first shaft section configured to at least selectively engage, and thereby at least selectively receive the drive torque generated in, the drive mechanism; and
a second shaft section coupled to the first shaft section and having a second outer diameter that is less than the first outer diameter, the second shaft section dimensioned to be disposed within either the drive mechanism or one of the plurality of driven mechanisms,
wherein:
when the first shaft section is simultaneously disposed in both the drive mechanism and the driven mechanism, the first shaft section simultaneously engages the drive mechanism and the driven mechanism, and transfers the drive torque to the driven mechanism, and
when the first shaft section is not disposed in the driven mechanism, the second shaft section engages, and transfers the drive torque to, the driven mechanism.

2. The drive shaft of claim 1, wherein the drive shaft further comprises:
a first end and a second end;
an inner surface that defines a quill shaft passageway, the quill shaft passageway extending longitudinally through the drive shaft between the first and second ends; and
a quill shaft disposed within the quill shaft passageway and extending from the drive shaft first and second ends.

3. The drive shaft of claim 2, further comprising:
a spring disposed within the quill shaft passageway and including a first end and a second end, the spring first end engaging at least a portion of the drive shaft inner surface, the spring second end adapted to engage the drive mechanism,
wherein, when the spring engages the drive mechanism the spring supplies a bias force to the drive shaft that urges the drive shaft toward the driven mechanism.

4. The drive shaft of claim 3, wherein:
the quill shaft includes a first end and a second end, the quill shaft first and second ends extending from the drive shaft first and second ends, respectively,
the quill shaft first end is configured to at least selectively engage a surface in the drive mechanism; and
the quill shaft further includes a stop disposed at least adjacent the quill shaft second end and extending radially from the quill shaft, the stop configured to prevent the quill shaft second end from entering the drive shaft opening.

5. The drive shaft of claim 1, wherein the shaft first section includes:
an outer peripheral surface; and
a shaft engagement groove formed in at least a portion of the first section outer peripheral surface.

6. The drive shaft of claim 5, wherein:
the shaft engagement groove is configured to receive a snap ring; and
the drive shaft further comprises a snap ring disposed within the shaft engagement groove, the snap ring configured to engage the drive mechanism.

7. The drive shaft of claim 5, wherein:
the shaft engagement groove is configured as one or more ball detents; and
the drive shaft further comprises a detent mechanism engaging the one or more ball detents and configured to engage the drive mechanism.

8. The drive shaft of claim 1, further comprising:
an intermediate shaft section disposed between, and coupled to, the first and second shaft sections, the intermediate section having a third outer diameter that is greater than the first and second outer diameters.

9. The drive shaft of claim 8, wherein the intermediate shaft section is dimensioned to be disposed in, and engage, the drive mechanism.

10. The drive shaft of claim 9, wherein:
the intermediate shaft section, when engaging the drive mechanism, transfers the drive torque to the driven mechanism via either the first shaft section or the second shaft section.

11. The drive shaft of claim 10, wherein:
when the drive torque is transferred to the driven mechanism via the first shaft section, the second shaft section is disposed within, and does not engage, the drive mechanism; and
when the drive torque is transferred to the driven mechanism via the second shaft section, the first shaft section is disposed within, and does not engage, the drive mechanism.

12. A drive shaft configured to be disposed between a drive mechanism and a plurality of driven mechanisms and to transfer a drive torque generated by the drive mechanism to one of the plurality of driven mechanisms, the drive shaft comprising:
a first shaft section having a first outer diameter and an end surface that defines a drive shaft first end, the first shaft section dimensioned to be disposed within the drive mechanism or simultaneously within the drive mechanism and one of the plurality of driven mechanisms, the first shaft section configured to at least selectively engage, and thereby at least selectively receive the drive torque generated in, the drive mechanism;
a second shaft section coupled to the first shaft section and having a second outer diameter and an end surface that defines a drive shaft second end, the second outer diameter less than the first outer diameter, the second shaft section dimensioned to be disposed within either the drive mechanism or one of the plurality of driven mechanisms;
a quill shaft passageway extending longitudinally through the drive shaft between the first and second shaft ends; and
a quill shaft disposed within the quill shaft passageway and extending from the drive shaft first and second ends
wherein:
when the first shaft section is simultaneously disposed in both the drive mechanism and the driven mechanism, the first shaft section simultaneously engages the drive mechanism and the driven mechanism, and transfers the drive torque to the driven mechanism, and
when the first shaft section is not disposed in the driven mechanism, the second shaft section engages, and transfers the drive torque to, the driven mechanism.

13. The drive shaft of claim 12, further comprising:
a spring disposed within the quill shaft passageway and including a first end and a second end, the spring first end engaging at least a portion of the drive shaft inner surface, the spring second end adapted to engage the drive mechanism,
wherein, when the spring engages the drive mechanism the spring supplies a bias force to the drive shaft that urges the drive shaft toward the driven mechanism.

14. The drive shaft of claim 13, wherein:
the quill shaft includes a first end and a second end, the quill shaft first and second ends extending from the drive shaft first and second ends, respectively,
the quill shaft first end is configured to at least selectively engage a surface in the drive mechanism; and
the quill shaft further includes a stop disposed at least adjacent the quill shaft second end and extending radially from the quill shaft, the stop configured to prevent the quill shaft second end from entering the drive shaft opening.

15. A drive shaft configured to be disposed between a drive mechanism and a plurality of driven mechanisms and to transfer a drive torque generated by the drive mechanism to one of the plurality of driven mechanisms, the drive shaft comprising:
a first shaft section having a first outer diameter and an outer peripheral surface, the first shaft section dimensioned to be disposed within the drive mechanism or simultaneously within the drive mechanism and one of the plurality of driven mechanisms, the first shaft section configured to at least selectively engage, and thereby at least selectively receive the drive torque generated in, the drive mechanism;
a shaft engagement groove formed in at least a portion of the first shaft section outer peripheral surface; and
a second shaft section coupled to the first shaft section and having a second outer diameter that is less than the first outer diameter, the second shaft section dimensioned to be disposed within either the drive mechanism or one of the plurality of driven mechanisms,
wherein:
when the first shaft section is simultaneously disposed in both the drive mechanism and the driven mechanism, the first shaft section simultaneously engages the drive mechanism and the driven mechanism, and transfers the drive torque to the driven mechanism, and
when the first shaft section is not disposed in the driven mechanism, the second shaft section engages, and transfers the drive torque to, the driven mechanism.

16. The drive shaft of claim 15, wherein:
the shaft engagement groove is configured to receive a snap ring; and
the drive shaft further comprises a snap ring disposed within the shaft engagement groove, the snap ring configured to engage the drive mechanism.

17. The drive shaft of claim 15, wherein:
the shaft engagement groove is configured as one or more ball detents; and
the drive shaft further comprises a detent mechanism engaging the one or more ball detents and configured to engage the drive mechanism.

18. A drive shaft configured to be disposed between a drive mechanism and a plurality of driven mechanisms and to transfer a drive torque generated by the drive mechanism to one of the plurality of driven mechanisms, the drive shaft comprising:
a first shaft section having a first outer diameter, the first shaft section dimensioned to be disposed within the drive mechanism or one of the plurality of driven mechanisms;
a second shaft section coupled to the first shaft section and having a second outer diameter that is less than the first outer diameter, the second shaft section dimensioned to be disposed within either the drive mechanism or one of the plurality of driven mechanisms; and
an intermediate shaft section disposed between, and coupled to, the first and second shaft sections, the intermediate section having a third outer diameter that is greater than the first and second outer diameters, the intermediate shaft section configured to engage, and thereby receive the drive torque generated in, the drive mechanism,
wherein the intermediate shaft section, when engaging the drive mechanism, transfers the drive torque to the driven mechanism via either the first shaft section or the second shaft section.

19. The drive shaft of claim 18, wherein:
when the drive torque is transferred to the driven mechanism via the first shaft section, the second shaft section is disposed within, and does not engage, the drive mechanism; and
when the drive torque is transferred to the driven mechanism via the second shaft section, the first shaft section is disposed within, and does not engage, the drive mechanism.
